(19) United States
(12) Patent Application Publication
(10) Pub. No.: US 2014/0026468 A1
(43) Pub. Date: Jan. 30, 2014

(54) Control of Subterranean Termites

(71) Applicants: Gregg Henderson, St. Gabriel, LA (US); Cai Wang, Baton Rouge, LA (US); Bal K. Gautam, Baton Rouge, LA (US)

(72) Inventors: Gregg Henderson, St. Gabriel, LA (US); Cai Wang, Baton Rouge, LA (US); Bal K. Gautam, Baton Rouge, LA (US)

(73) Assignee: Board of Supervisors of Louisiana State University and Agricultural and Mechanical College, Baton Rouge, LA (US)

(21) Appl. No.: 13/948,335

(22) Filed: Jul. 23, 2013

Related U.S. Application Data
(60) Provisional application No. 61/675,124, filed on Jul. 24, 2012.
(60) Provisional application No. 61/723,895, filed on Nov. 8, 2012.

(51) Int. Cl. A01M 1/20

(52) U.S. Cl. CPC A01M 1/2011
USPC 43/131; 43/132.1

(57) ABSTRACT

A biological control is disclosed for termites, including subterranean termites such as C. formosanus, comprising a mixture of a chitin synthesis inhibitor such as lufenuron with a pathogen or opportunistic pathogen. The combination greatly enhances the effectiveness above that of the individual components. For example, P. aeruginosa is commonly found in association with termites, but it is not normally harmful to termites. However, in the presence of lufenuron, P. aeruginosa becomes an opportunistic pathogen that kills termites. As another example, B. thuringiensis, which otherwise has shown only limited effectiveness against termites, has greatly enhanced lethality in combination with lufenuron. In another aspect a termite toxicant is administered to termites in a clay-based bait. Clay acts as an attractant for subterranean termites such as C. formosanus, and a clay bait can increase a colony's consumption of a toxicant.

The benefit of the Jul. 24, 2012 filing date of U.S. provisional patent application Ser. No. 61/675,124; and of the Nov. 8, 2012 filing date of U.S. provisional application Ser. No. 61/723,895 are claimed under 35 U.S.C. §119(e). The complete disclosures of both priority applications are hereby incorporated by reference in their entirety.

### TECHNICAL FIELD

This invention pertains to the control of subterranean termites.

### BACKGROUND ART

Termites are a varied group of insects of the order Isoptera. Subterranean termites belong to the family Rhinotermitidae. The Formosan subterranean termite, Coptotermes formosanus Shiraki, is a major worldwide pest that attacks both living trees and structural wood, causing great economic damage. It has become one of the most destructive termite species in the southern United States and Hawaii since it was first introduced from southeast Asia in the early twentieth century.

Four principal methods have been used to control Coptotermes: (1) chemical and physical barriers to prevent termites from attacking wood; (2) wood preservatives and termiticides used to protect infested or susceptible wood; (3) destruction of a termite colony by excavation of the nest; and (4) slow acting toxic bait stations. See, for example, U.S. Pat. Nos. 4,921,696; 5,303,523; 5,609,879; 5,802,779; and 5,874,097. Currently, the two most widely used methods for the control of this pest are termite baiting and liquid soil termiticides. Although chemical insecticides are popular in the termite control industry, they are not free from shortcomings. The main concerns of liquid termiticides include their potential effects on non-target organisms, and possible pollution of soil and water. An effective biological control method could provide an environmental friendly and sustainable option for the control of C. formosanus, but none are currently available.

Bacillus thuringiensis (Bt) is a group of gram-positive bacteria that produce a number of compounds known to be toxic to insects, primarily to insects in the orders Diptera, Lepidotera, and Coleoptera. For example, Bt subspecies israelensis (Bti) has been used for the biological control of mosquitoes and other insect pests. One Bt-containing composition, sold under the name Mosquito Dunks™, kills mosquito larvae in ponds and standing water. See U.S. Pat. Nos. 4,631,857 and 6,898,898. Bt has been tested against termites, but with only limited success. Although Bt spp. are typically not pathogens of termites, some Bt subspecies have been reported to be toxic to some termite species. See, e.g., R. V. Smythe et al., “The susceptibility of Reticulitermes flavipes (Kollar) and other termite species to an experimental preparation of Bacillus thuringiensis Berliner,” J. Invertebr. Pathol. vol. 7, pp. 423-426 (1965); and K. I. Khan et al., “Pathogenicity of locally discovered Bacillus thuringiensis strain to the termites: Heterotermes indicola (Wassman) and Microcerotermes championi (Snyder),” Pak J. Sci. Res. Vol. 29, pp. 12-13 (1977). Khan et al. reported that the termites Reticulitermes flavipes, Heterotermes indicola, and Microcerotermes championi are susceptible to Bt subspecies thuringiensis (Btt). D. Singha et al., “In vitro pathogenicity of Bacillus thuringiensis against tea termites,” J. Biol. Control vol. 24, pp. 279-281 reported that Bti can effective against tea termites in India, Microtermes obesi (Holmgren) and Microcerotermes beesoni (Snyder). Although Bt has sometimes worked well to control termites in the laboratory, results in the field have been less promising, perhaps because of the typically short duration of Bt pesticide products in a natural environment. It has been reported, for example, that Btt loses all spore viability and insecticidal activity within four days without the protection of ultraviolet screens. In addition, many studies have found that microbial pathogens do not work well to control C. formosanus in the field, due to its strong immune response and social behaviors.

“Integrated pest management” combines chemical pesticides and biological control agents. The successful combination of these two very different strategies depends on a complex interplay among C. formosanus behavior, the chemical pesticide, and the termite pathogens. Some studies have reported that some immune inhibitors such as dexamethasone and ibuprofen can increase the mortality of C. formosanus exposed to the insect bacterial pathogen Serratia marcescens. However, the high cost and low environmental stability of these immune inhibitors has limited their use in termite control programs.

Lufenuron, a chitin inhibitor, has been commercially used for the control of cat fleas. Its effectiveness as an active ingredient (toxicant) in termite bait has been confirmed by both laboratory and field studies. Lufenuron and other chitin inhibitors block the formation of the exoskeleton, thus reducing the ability of the termite cuticle to operate as a barrier against microbial pathogens. H. Merzendorfer, “Chitin synthesis inhibitors: old molecules and new developments,” Insect Sci. vol. 20, pp. 121-138 (2013) has stated that some chitin synthesis inhibitors can inhibit the formation of the peritrophic membrane of insects. Lufenuron may suppress disease resistance of termites by disrupting the function of the peritrophic membrane to prevent microbial infection in the midgut. Lufenuron also appears to influence cellular responses, humoral responses, and metabolic enzymes associated with termite immunity.

Pseudomonas aeruginosa and Serratia marcescens are among the hundreds of bacterial species that are naturally associated with C. formosanus. The strong immune responses and pathogen defense behaviors of C. formosanus greatly decrease the risk of microbial infection. For these reasons, authors such as T. Chouvenc et al., “Fifty years of attempted biological control of termites—Analysis of a failure,” Biological Control, vol. 59, pp. 69-82 (2011) have questioned whether biological control of termites will ever become practical: “[B]iological control has essentially failed, or failed to be developed, as a method for commercial termite control . . . . [A]ll efforts to date have failed to produce effective control.”

W. Connick et al., “Increased mortality of Coptotermes formosanus (Isoptera: Rhinotermitidae) exposed to eicosanoid biosynthesis inhibitors and Serratia marcescens (Eubacteriales: Enterobacteriaceae),” Environ. Entomol., vol. 30, pp. 449-455 (2001) reported that some immune inhibitors such as dexamethasone, ibuprofen, and ibuprofen sodium salt can significantly increase the mortality of C. formosanus exposed to S. marcescens, at least at high concentrations of the bacteria.

M. Bulmer et al., “Targeting an antimicrobial effector function in insect immunity as a pest control strategy,” Proc. Natl. Acad. Sci. Early Edition (2009) reported that D-δ-gluconolactone can block the β(1,3)-glucanase effector activity of termite Gram-negative bacteria binding protein-2 (tGNBP-2) and accelerate mortality of Nasutitermes corniger (Motschulsky) resulting from infection by M. anisopliae, Serratia spp. and Pseudomonas spp.

Bait systems currently in use for termites are generally housed in plastic containers for environmental safety concerns. Termites must pass through holes in the plastic container to get to a food source. While a container enhances environmental safety, it can also reduce exposure of termites to the bait.

Some termites use clay for nest construction or mound building. Compared to “higher” mound-building termites, few studies have reported the use of clay by subterranean termites (“lower” termites). G. Henderson, “The termite menace in New Orleans: Did they cause the floodwalls to tumble?” American Entomologist, pp. 156-162 (Fall 2008) reported that the Formosan subterranean termite sometimes modifies its habitat by using clay to fill tree cavities (which are often caused by consumption of wood by the termites themselves). To the knowledge of the inventors, there have been no prior reports suggesting that clay might act to modify the behavior of C. formosanus.

M. Cornelius et al., “Effect of Soil Type and Moisture Availability on the Foraging Behavior of the Formosan Subterranean Termite (Isoptera: Rhinotermitidae),” J. Econ. Entomol., vol. 103, pp. 799-807 (2010) reported that physical properties of the soil affected both tunneling behavior and shelter tube construction. Termites tunneled through sand faster than top soil and clay. In containers with top soil and clay, termites built shelter tubes on the sides of the containers. In containers with sand, termites built shelter tubes directly into the air and covered the sides of the container with a layer of sand. The interaction of soil type and moisture availability affected termite movement, feeding, and survival. In assays with moist soils, termites were more likely to aggregate in top soil over potting soil and peat moss. However, termites were more likely to move into containers with dry peat moss and potting soil than containers with dry sand and clay.

Social behavior plays an important role in termite disease resistance. For example, termites will often isolate dead cohorts in “quarantine barriers” made of soil and fecal pellets. Chemical constituents of fecal pellets of Zootermopsis angusticollis (Hagen) and Reticulitermes flavipes (Kollar) play a role in inhibiting spore germination of the fungus Metarhizium anisopliae (Metchnikoff). C. formosanus actively detects, drags, and buries the carcasses of dead termites.

C. Wang et al., “Evidence of Formosan subterranean group size and associated bacteria in the suppression of entomopathogenic bacteria, Bacillus thuringiensis subspecies israelensis and thuringiensis,” Ann. Entomol. Soc. Am., vol. 160, pp. 454-462 reported that the presence of C. formosanus can suppress the growth of Bacillus thuringiensis subspecies israelensis and thuringiensis, and that the suppression is enhanced by increased group size.

There is an unfilled need for improved subterranean termite controls, particularly for effective biological controls.

### DISCLOSURE OF THE INVENTION

We have discovered an effective biological control for termites, including subterranean termites such as C. formosanus, comprising a mixture of a chitin synthesis inhibitor such as lufenuron with one or more bacterial or fungal species that are termite pathogens or opportunistic pathogens of termites. The combination greatly enhances the effectiveness above that of the individual components. The bacteria or fungi may be species that are not toxic to the termites in the absence of the chitin synthesis inhibitor. For example, P. aeruginosa is commonly found in association with termites, but it is not normally harmful to termites. However, in the presence of lufenuron, P. aeruginosa becomes an opportunistic pathogen that kills termites. As another example, B. thuringiensis, which otherwise has shown only limited effectiveness against termites, has greatly enhanced lethality in combination with lufenuron. This synergistic and cost-effective combination reduces the amount of the lufenuron required to kill the termites, it reduces the time frame for mortality, and enhances lethality. In a preferred embodiment, the mixture is administered to the termites in a clay-based bait. We have discovered, surprisingly, that clay acts as an attractant for subterranean termites such as C. formosanus, and that a clay bait can increase a colony's consumption of a toxicant—including, but not limited to the preferred lufenuron/toxic bacteria combination. Other toxicants may also be used in combination with clay to enhance termite consumption of the toxicants.

We used an in vivo mortality bioassay in bacteria-lufenuron experiments to test the effects of lufenuron and bacteria combinations against termites. Our experiments were designed to test: (1) whether termites pre-fed on lufenuron showed higher mortality when exposed to bacteria, and (2) whether termites pre-fed on lufenuron exhibited different behavioral patterns in response to infected and dead termites.

We also found that clay enhances the effectiveness of the lufenuron/bacteria combination as a termiticide. We expect that clay will also enhance the effect of other termite toxicants. To the inventors' knowledge, prior termite baits have not incorporated clay in any appreciable concentration. Toxicants in existing baits are instead normally administered as a mixture with a cellulosic material. We found, surprisingly, that clay acts as a termite attractant in clay choice experiments. We observed significantly and substantially greater numbers of termites aggregated in chambers containing clay, regardless of colony groups, observation periods, or nutritional status (fed or starved).

A Bti-containing product, Summit® Mosquito Dunks® (Summit Chemical Company, Baltimore, Md.) is marketed specifically for use against mosquito larvae living in standing water. To our knowledge, Mosquito Dunks® (or similar products) have not previously been used against termites. Unlike mosquito larvae, termites do not live in standing water. Furthermore, termites feed on cellulosic materials. Although the exact composition of Mosquito Dunks is not known to the inventors, they do not appear to contain cellulosic materials, but instead they appear to be based on a clay substrate. We discovered, quite unexpectedly, that C. formosanus exposed to Mosquito Dunks® had higher mortality and lower foraging activity as compared to controls (data not shown). Following this surprising observation, we began experiments using clay as a bait, and found that clay acts as an attractant for C. formosanus, and that clay may be used to enhance the delivery of a toxicant to a termite colony. Bacteria adhere well to clay, so clay is a good substrate for a bait to deliver toxic bacteria to termites.

In earlier efforts to develop a biological termite control method, we had supplied stalks (i.e., cellulose) from three Bt-genetically modified maize hybrids to termites. These hybrids expressed 7 different Bt proteins. No significant differences from controls were found in consumption, mortality, or tunneling in our tests. One would have expected Bt-containing cellulosic materials such as these to be toxic to termites, but they were not. These surprising results illustrate the difficulties that exist in effectively delivering toxicants to termites. If cellulose laced with Bt toxin is not toxic to termites, it is surprising that Bt bacteria may be effectively used against termites at all.

An advantage to a clay-containing Bt bait station is that (subject to obtaining appropriate regulatory approvals) the bait station may be placed in direct contact with the ground, and it need not be isolated within a plastic container. The bait station should be relatively safe towards non-target species, particularly to non-arthropods. Termites then have access to a larger contact area with the toxicant, the termites are not hindered by a plastic container, and attractants that are added to the bait can then move through soil more easily and quickly to increase the attraction zone for termites.

### BRIEF DESCRIPTION OF THE DRAWINGS

FIGS. 1A through 1H show the mean mortality (±SE), tunnel length (±SE), weight of 10 termites (±SE), and consumption (±SE) by termites for the untreated Bti Mosquito Dunk®, the Autoclaved Mosquito Dunk®, and the control treatments. Different letters denote a significant difference (P<0.05).

### MATERIALS AND METHODS

### Example 1

### Termites

Two colonies of C. formosanus termites were collected from Brechtel Park, New Orleans, La. using milk crate traps. The colonies were kept in 140-liter containers (trash cans) with moist yellow pine (27±1° C.) for a maximum of 1 month before testing.

### Example 2

### Termite Pathogenic Bacteria

P. aeruginosa and S. marcescens were isolated from C. formosanus and identified by 16S rRNA sequencing. B. thuringiensis subspecies israelensis (BO was isolated from Summit® Mosquito Dunks® and confirmed by colony growth characteristics and Schaeffer-Fulton staining. The three bacterial species were streaked on Luria-Bertani (LB) agar plates and kept at 4° C. for less than one month before setting the bioassay.

### Example 3

### Chitin Synthesis Inhibitor

Lufenuron disrupts the formation of cuticle when termites molt, and this disruption can kill termites at sufficiently high levels of lufenuron. A lethal dose is usually about 1500 ppm or higher, and mortality occurs after about a month. The dose and time are similar to those known for other chitin inhibitors/growth regulators, including but not limited to, hexaflumuron, noviflumuron, diflubenzuron, and novaluron, which have been used for several years against termites.

### Bacteria-Lufenuron Experiments

### Example 4

### Termite Pre-Feeding Conditions

Twelve filter paper discs (9 cm, Ahlstrom® grade 617) were individually weighed. Lufenuron (Sigma-Aldrich Co. LLC, St. Louis, Mo.) was dissolved in acetone to make a 1000 ppm solution, and 1 ml of this solution was pipetted onto each of the filter papers. The same amount of acetone only was added to another set of 12 filter paper discs (non-treated controls). The filter papers were then placed under a fume hood for about 48 hours to evaporate the acetone completely. The treated and non-treated filter papers were placed in separate Petri dishes (150 by 15 mm, Fisherbrand®), such that each of 4 dishes contained 6 filter paper discs (2.8±0.01 g). The filter papers in each dish were moistened with 8 ml sterile distilled water. One thousand termites from a colony (colony 1: 90% workers and 10% soldiers; colony 2: 100% workers, according to their collected colony structures) were released in a dish, such that Colony 1 termites and Colony 2 termites were each released into both treated and non-treated dishes. The Petri dishes were then sealed with Parafilm® (Structure Probe, Inc., West Chester, Pa.) to maintain moisture and held in an incubator (3710, Form a Scientific, Inc., Marietta, Ohio) at 28° C. and total darkness for 8 days. At day 8, the condition of termites (active or inactive), filter paper consumption, and survival rate were recorded.

### Example 5

### Bioassay Area

The mortality bioassay contained 8 treatments. Termites pre-fed on lufenuron treated- or non-treated filter papers were exposed either to no bacteria or to one of three species of bacteria: P. aeruginosa, S. marcescens, or B. thuringiensis. There were 12 replicates in each treatment (six replicates for each termite colony).

Before setting the bioassay, stored bacteria were streaked on brain-heart infusion agar plates and incubated at 30° C. for 24 hours. A single colony of each bacterial species was picked from the inoculated plates and transferred to 1 ml brain-heart infusion broth and incubated at 30° C. on a shaking platform set at 200 rpm for 12 hours. Two-hundred micro-liter broth of each species was then inoculated in 50 ml brain-heart infusion broth and incubated at 30° C. for 34 hours with shaking (200 rpm). Ten milliliter broth of each bacterium was centrifuged at 4500 rpm for 20 minutes at 4° C. The concentrate was washed with 10 ml sterile distilled water and centrifuged again at 4500 rpm for 20 min. Then the concentrate was suspended and diluted with sterile distilled water to an OD₆₀₀ value of 1.0, corresponding to a concentration of about 1×10⁹ cells/ml. One milliliter of bacterial suspension was added to a filter paper disc placed on the bottom of a Petri dish (100 by 15 mm) for each treatment. From each colony, 25 termites pre-fed on lufenuron treated- or non-treated filter papers (colony 1: 23 workers and 2 soldiers; colony 2: 25 workers) were released into a Petri dish for each treatment. Petri dishes were then sealed by Parafilm and kept in the incubator set at 28° C. in total darkness.

The mortality for each experimental unit was recorded on days 2, 4, 6, 8, 10, and 12 after setting the bioassay. The behavioral responses of infected termites and dead termites were also observed and recorded at the same times.

### Example 6

### Data Analysis

For each bacterial species, mortality was calculated and compared by analysis of variance (ANOVA) among the following groups: (1) termites both pre-fed on lufenuron and exposed to bacteria; (2) termites only pre-fed on lufenuron; (3) termites only exposed to bacteria; and (4) termites neither pre-fed on lufenuron nor exposed to bacteria (control). Effects on termite condition, mortality and consumption were determined after 8 days of pre-feeding on lufenuron-treated or non-treated filter papers. When a single colony displayed a significant effect, it was analyzed separately. Otherwise the data were combined and analyzed with colony as a random effect. SAS PROC MIXED model (SAS Institute, Cary, N.C., 2011) was used to analyze the data, and Tukey's honestly significant difference (HSD) was used for means comparison. Significance levels were determined at α=0.05.

In other experiments (data not shown) we have found that lufenuron at concentrations down to at least as low as 250 ppm enhances the effectiveness of pathogenic bacteria against termites.

### Clay Choice Experiments

### Example 7

### Importance of Clay to Subterranean Termites

Grass-eating (“higher”) termites consume a large amount of clay, but subterranean (“lower”) termites consume relatively little clay. To the knowledge of the inventors, previous termite baits have not contained significant amounts of clay.

Clay has many unique properties. Clays tend to be alkaline, which is beneficial for the growth of some bacteria. It retains more water than many other soil types, and it can become very hard when dry. Its small particle size allows it to be easily ingested. Formosan termites transport clay into the cavities of trees, both to waterproof the cavities and to hold water. We hypothesize that if the clay is wet during transportation by termites, the termites will ingest some of the clay.

Most types of clay found worldwide may be used in conjunction with the present invention. Preferably, the clay particle size is less than about 2 μm, and the pH is between about 6 and about 9 for optimal acceptance by termites and maintenance of bacteria.

### Example 8

### Clay Choice Test

We hypothesized that clay is attractive to C. formosanus, a finding that has not previously been reported. To test this hypothesis, two-choice tests were conducted to study the preference of C. formosanus for clay under fed or starvation conditions. We observed the percentage of termites on clay, their tunneling activity in clay, and their consumption of clay when fed and when starved.

### Example 9

### Materials

Clay was collected from the backyard of one of the inventors in St. Gabriel, La. Construction sand was purchased from Louisiana Cement Product (Baton Rouge, La.). The Coastal Wetlands Soils Characterization Lab of Louisiana State University analyzed the samples (Table 1).

TABLE 1
Characteristics of clay and sand used in the choice tests.

| | | | Particle Size | | | |
|---|---|---|---|---|---|---|
| | | | Distribution (%) | | | Textural |
| Sample | pH (1:1) | O.M. (%) | Sand | Silt | Clay | Class |
| Clay from | 7.09 | 11.58 | 7.6 | 48.9 | 43.5 | Silty Clay |
| St. Gabriel | | | | | | |
| Construction | 5.59 | 0.19 | 99.2 | 0.2 | 0.6 | Sand |
| sand | | | | | | |

### Example 10

### Methods

Step 1.

Before testing, the samples were autoclaved (121° C. for 1 hour) and dried in an oven dryer (30° C. for 2 days). Eighty-five grams dried clay or sand were put in a Ziploc® bag and completely mixed with 15 ml deionized water. Then 1.2 g of each sample was kneaded into small blocks.

Step 2.

The preference of termites for clay was tested using two-choice bioassays. Bioassay arenas were three-chambered transparent polyacrylic containers with small holes (diameter≈1.5 cm) at the bottom of both inner walls of the chamber. Thirty grams of 15% moisture sand was placed in each chamber as a substrate layer.

Step 3.

To test termite preference under fed condition, five filter paper discs (4.2 cm, Ahlstrom®) were placed on the substrate in both left and right chambers. Also, a clay or sand block was placed on the filter paper in the left or right chamber of each container.

Step 4.

To test termite preference under starvation conditions, only a clay or sand block was placed on the substrate of each container.

Each test was repeated 12 times (six replicates for each termite colony group). Fifty termites from each colony were released to the center chamber of the container. The containers were sealed with Parafilm® and kept in an incubator set 26° C. in darkness.

### Example 11

### Data Analysis

At days 7, 14, and 21, the numbers of termites in each chamber (clay side, center, and sand side) were counted. Different colored pen inks marked the tunnels in each observation period, and the lengths of tunnels under each chamber were measured. The percentages of termites and lengths of tunnels in each chamber were compared by analysis of variance (ANOVA), followed by Tukey's HSD for means comparison. Dry weight of filter paper in clay or sand side was weighed before and after the experiment to determine consumption, and compared by paired t-test. Significance levels were determined at α=0.05.

### Bti Experiments

### Example 12

### Materials

Bacillus Thuringiensis Subs. Israelensis (Bti) Experiment Materials:

The following materials were used in these experiments:
Agar Luria-Bertani (LB) growth medium (tryptone 1%, yeast 0.5%, NaCl 1% and agar 1%)
Liquid Luria-Bertani LB growth medium (tryptone 1%, yeast 0.5% and NaCl 1%)
15% moist sand made with sterile sand (autoclaved cycle 11) and distilled water
Summit® Mosquito Dunks®

### Example 13

### Isolation of Bti from Mosquito Dunks

Step 1:

The equipment was autoclaved (cycle 2, 121° C. for 15 minutes, dry time 15 minutes): 250 ml conical flask, 100 ml measuring cylinder, 1 ml tips, 1.5 ml Eppendorf (EP) tubes, toothpicks, and mortar (×2). The culture and liquid were autoclaved (cycle 9, 121° C., 15 min): test tubes with 10 ml distilled water, 300 ml agar LB, 200 ml liquid LB, 500 ml distilled water. The plates were prepared: 20 ml agar LB in each Petri dish, cooled to room temperature, and stored at 4° C.

Step 2:

Ten grams of Mosquito Dunks® material were ground to a powder with mortar and pestle. The powder was transferred to a 250 ml conical flask with 90 ml distilled water, and shaken at 500 rpm for 120 minutes to make a 10% (w/v) solution.

Step 3:

1.0 ml of the 10% (w/v) solution was added to a test tube with 9 ml sterile distilled water, and shaken to make a 1% (w/v) solution. The process was repeated to make 10⁻³, 10⁻⁴, 10⁻⁵, 10⁻⁶, 10⁻⁷, 10⁻⁸, 10⁻⁹, and 10⁻¹⁰ (w/v) solutions. (E.g., 10⁻³=0.1% (w/v)).

Step 4:

0.1 ml of the 0.0001% (w/v) solution was placed on the surface of agar LB and smeared to make a 0.00001% gradient plate. The process was repeated to make 10⁻⁸, 10⁻⁹, and 10⁻¹⁰ gradient plates. Each concentration was repeated three times. The gradient plates were put in an incubator at 30° C. overnight.

Step 5:

Steps 1 through 4 were repeated with autoclaved Mosquito Dunks (cycle 12, 121° C. for 60 minutes, dry time 15 minutes).

Analysis:

Using the gradient plate method, the Bti bacterial concentration in the Mosquito Dunks® was found to be about 2.7×10⁹ c.f.u. per gram. Autoclaving the Mosquito Dunks® for 300 minutes at 121° C. did not completely kill all Bti spores, but the bacterial concentration dropped to about 100 c.f.u. per gram. Malachite green stain and safranin stain confirmed that colonies isolated from Mosquito Dunks® were Bti. (Microscopic observation found red bacteria cells and green spores on prepared smears.)

### Example 14

### Susceptibility of Formosan Termites to Bti

Step 1:

The equipment was autoclaved (cycle 2): 250 ml conical flask, 100 ml measuring cylinder, 1 ml tips, 1.5 ml EP tubes. The liquids were autoclaved (cycle 9): 1000 ml distilled water, 500 ml liquid LB, 1000 ml distilled water.

Step 2:

The stored Bti was transferred to a 250 ml conical flask with 100 ml liquid LB, and shaken at 200 rpm for 36 hours at 30° C.

Step 3:

The mixture of spores, solids, and cells was centrifuged at 5000 rpm for 20 minutes at 4° C. The supernatant was discarded. The concentrate was diluted with 100 ml sterile distilled water, and shaken to completely to wash the bacteria. The dilution was centrifuged again at 5000 rpm for 20 minutes, and washed again.

Step 4:

The dilution was centrifuged again at 5000 rpm for 20 minutes at 4° C. The supernatant was discarded. The concentrate was diluted with sterile distilled water. The process was repeated to make 10⁴, 10⁵, 10⁶, 10⁷, 10⁸, and 10⁹ cell (spore)/ml solutions as in previous experiments.

Step 5:

30 grams moist sand were placed in a Petri dish as a substrate layer. 250 Bti solution was added on filter paper (55 mm diameter) such that the concentrations of Bti on filter paper were 10⁴, 10⁵, 10⁶, 10⁷, 10⁸ and 10⁹ cell (spore)/g.

Step 6:

The bioassays were set by putting treated and untreated filter papers in the centers of Petri dishes on a moistened sand substrate. The bioassays tested seven treatments: 0 (control), 10⁴, 10⁵, 10⁶, 10⁷, 10⁸ and 10⁹ cell (spore)/g of filter paper. Each treatment was repeated 5 times. 50 workers and 5 soldiers were placed in each replicate.

Step 7:

Bioassays were covered with thick paper to maintain darkness; dead termites were removed every day; the median lethal time (LT₅₀) of each replicate was recorded; water was added when the sand moisture decreased; the experiment was maintained for 7 days to 14 days (not fixed). At the end of the experiment, the bottom side of each Petri dish was scanned. The mortality and food consumption of each replicate was recorded.

Analysis:

The normality of data (survival number and food consumption) was tested by the SAS 9.1 UNIVARIATE procedure. When the data was normally distributed, Tukey's HSD was used to compare the means between treatments. When the data was not normally distributed, and the efforts of square root transformation also failed, the rank test was used to compare the difference between treatments. Significance levels were determined at α=0.05.

### Example 15

### Anti-Termite Effects of Mosquito Dunks® on Formosan Termites

Step 1:

The Mosquito Dunks® were autoclaved (cycle 2) four times (121° C., 4 hours). 30 grams of moist sand were placed in a Petri dish as a substrate layer. A weighted, sterile wood block was placed on the substrate.

Step 2:

Bioassays were set with 50 worker and 5 soldier termites in each replicate.
Treatment 1: One dunk was placed on the filter paper; and 10 ml distilled water was added.
Treatment 2: One dunk was placed on the filter paper; and 10 ml solution of Bti spores and cells (3×10⁹ c.f.u. per ml) was added.
Control 1: One autoclaved dunk was placed on the filter paper; and 10 ml distilled water was added.
Control 2 (Blank control): One autoclaved dunk was placed on untreated filter paper.

Step 3:

Bioassays were created with additional treatments for 2 months, 1 month, and 1 day, with and without additional Bti spores and cells.

Step 4:

Bioassays were covered with thick paper to maintain darkness; dead termites were removed every day; the median lethal time (LT₅₀) of each replicate was recorded; water was added when the sand moisture decreased; the experiment was maintained for 7 days to 14 days (not fixed). At the end of the experiment, the bottom side of each Petri dish was scanned. The mortality and food consumption of each replicate were recorded.

Analysis:

Analysis was performed as described in the previous example.

### Example 16

### Interaction of Bti and Formosan Termites

Step 1:

The equipment was autoclaved (cycle 2: 121° C. for 15 minutes, dry time 15 minutes): 10 μL tips, 1 forceps; (cycle 9: 121° C. for 15 min): 150 ml agar LB.

Step 2:

20 ml agar LB medium was placed into each Petri dish, cooled to room temperature, and stored at 4° C.

Step 3:

1 ml of Bti was transferred to a 1.5 ml EP tube, and stored at 4° C.

Step 4:

10 μL tips were used to touch the liquid Bti culture. (Trace amounts of Bti remained in tips.) The tips were touched to the surface of agar LB so that the Bti was transferred to the agar medium. Each Petri dish was touched 4 times. 10 plates were prepared in total.

Step 5:

The plates were placed in an incubator at 30° C. After 4 Bti colonies had developed in each plate, the plates were transferred from the incubator to room temperature. Initial photos of the plates were taken.

Step 6:

50 worker termites and wet filter paper (55 mm) were placed on each plate. The plates were marked 1 through 5. Two plates without termites were marked as Controls 1 and 2.

Step 7:

On the first day, photos were taken every 2 hours; the number of holes made by termites and the consumption of Bti were recorded. On subsequent days, photos were taken once a day, and the mortality of termites and the growth condition of Bti colonies were recorded.

Analysis:

We found that putting termites in Bti culture mediums can control the growth of Bti colonies, which showed that there was some interaction between the termites and the Bti bacteria.

### Example 17

### Using Clay to Enhance Biological Control of Termites

Prior attempts at biological control of termites with Bt have generally not been very successful. We have found, quite unexpectedly, that including clay in the bait can greatly enhance Bt-induced mortality in termites. The particles in a clay carrier for Bt are small and easily ingested by termites. Moreover, many clays tend to be alkaline, providing an environment that enhances both Bt survival and Bt activity in the termite gut.

Step 1.

Bti, isolated as in the previous examples, was kept at 4° C. for less than one month. Bti was inoculated on LB agar plates and incubated at 30° C. for 18 hours. A single colony of Bti was transferred to an EP tube containing 1 ml liquid LB. Tubes were shaken at 200 rpm and incubated at 30° C. for 24 hours.

Step 2.

250 μL Bti culture was transferred to a 250 ml conical flask with 100 ml liquid LB and incubated at 30° C. for 4 days. 10 ml culture containing a mixture of spores, solids, and cells was centrifuged at 5000 rpm for 15 minutes. The concentrate was diluted with 10 ml sterile distilled water and centrifuged again at 5000 rpm for 15 minutes; this step was repeated twice. The resulting concentrate was diluted with sterile distilled water to make 6×10⁹ and 1.2×10¹⁰ cell/ml solutions (estimated by the gradient plate method).

Step 3.

Petri dishes were covered with foil paper. A wood block (25 mm×25 mm×5 mm) was placed in the center of the dish. 20 g clay (autoclaved at 121° C. for 1 hour) was also placed in the Petri dish. 10 ml distilled water or Bti solution (6×10⁹ or 1.2×10¹⁰ cell/ml) was added to clay (Paws and Claws Natural™ Kitty Litter, Tenn.). After the clay was moistened and had become malleable, it was shaped into a disc. Then the Petri dishes were inverted and the foil paper removed, yielding clay discs containing different concentrations of Bti (0, 3×10⁹ or 6×10⁹ cell/g). Sand discs were made in the same way. (The sand discs were moist and were handled carefully to keep them from disintegrating.)

Step 4.

The experiment comprised two groups: a sand group and a clay group. Each experimental group included three treatments with different concentration of Bti (0, 3×10⁹ or 6×10⁹cell/g). Each treatment was repeated 12 times (six replicates for each colony).

Step 5.

The bioassay arenas were 90×38 mm containers. Sand was autoclaved (121° C., 45 minutes) and mixed uniformly with distilled water in a Ziploc® bag to make the 15% moisture sand. Thirty grams of wet sand were placed in each bioassay arena and pressed into the bottom of a Petri dish to form a thin layer of substrate. A clay disc or sand disc was placed on the substrate. 100 termites were placed in each experimental unit. The bioassay was maintained in darkness in a 27° C. incubator for 31 days.

Analysis:

Before and after the experiment, the dry weight of wood was weighed to measure consumption. At the end of the experiment, the mortality of termites was recorded. Ten termites were randomly selected in each experimental unit and weighed. The bottom side of each container was scanned to determine the tunneling condition. The mortality, length of tunnels, termite weight and consumption of each treatment was analyzed by UNIVARIATE statement of SAS 9.3 (2011 SAS Institute Inc., Cary, N.C.). If the data were normally distributed, ANOVA and Tukey's HSD test were used to compare the mean of each treatment. If the data were not normally distributed, a rank was assigned and compared by ANOVA and the Kruskal-Wallis test. All significance levels were determined at a<0.05.

### Results and Discussion

### Bacteria-Lufenuron Experiment Results

### Example 18

### Termites Pre-Fed on Lufenuron-Treated or Nontreated Filter Paper

For both colonies, termites fed on lufenuron-treated filter papers became inactive and consumed less at the end of 8 days as compared with termites fed on non-treated filter papers; but mortality of the two treatments was similar (Table 2). Because there were differences in consumption and mortality between the two termite colonies feeding on non-treated filter papers, data were analyzed separately.

TABLE 2
Conditions, average weight (n = 25), consumption
and survival rate of termites pre-fed on lufenuron-
treated or non-treated filter paper for 8 days.

| | | | | Survival |
|---|---|---|---|---|
| Termite colony | Pre-treatment | Condition | Consumption | rate |
| Colony 1 | lufenuron-treated | inactive | 0.55 g | 91.1% |
| | non-treated | active | 1.20 g | 93.0% |
| Colony 2 | lufenuron-treated | inactive | 0.56 g | 76.1% |
| | non-treated | active | 2.01 g | 81.9% |

### Example 19

### Termites Exposed to P. Aeruginosa

For termite colony 1 (Table 3), on day 2 mortality of termites pre-fed on lufenuron-treated filter paper and exposed to P. aeruginosa (LU-PA) was significantly higher than termites only exposed to P. aeruginosa (PA) or control (F3, 20=7.58, P=0.0014). None of the three treatments was significantly different from termites only pre-fed on lufenuron-treated filter paper (LU). However, from day 4 to day 12, mortality of termites in the treatment LU-PA was significantly higher than that of the other three treatments (P<0.05).

For termite colony 2 (Table 3), on day 2 mortality of the treatment LU-PA was significantly higher than the treatment PA or control (F3, 20=8.13, P=0.0010). None of them were significantly different from the treatment LU. From day 4 to 12, mortality of the treatment LU-PA was significantly higher than that of the three other treatments. From day 4 to 10, mortality of the three treatments LU, PA, and control did not significantly differ from one another (P<0.05). On day 12, mortality of the treatments PA and LU were similar to each other but significantly higher than the control (F3, 19=45.52, P<0.0001). The termites infected by P. aeruginosa turned yellow or green after they died.

TABLE 3
Daily mortality (mean ± SEM) of termites: (1) both pre-treated with lufenuron and
exposed to P. aeruginosa (LU-PA), (2) only pre-treated with lufenuron (LU), (3) only
exposed to P. aeruginosa (PA), and (4) neither pre-treated with lufenuron nor exposed
to P. aeruginosa (control).

| | | Mortality (%) | | | | |
|---|---|---|---|---|---|---|
| termite colony | day | LU-PA | LU | PA | control | F, P |
| Colony 1 | 2 d | 10.0 ± 1.7 (a*) | 4.0 ± 2.5 (ab) | 0.7 ± 0.7 (b) | 0.7 ± 0.7 (b) | 7.58, 0.0014 |
| | 4 d | 24.7 ± 6.9 (a) | 5.3 ± 2.2 (b) | 5.3 ± 1.3 (b) | 2.7 ± 0.8 (b) | 7.57, 0.0014 |
| | 6 d | 40.0 ± 5.8 (a) | 8.7 ± 3.2 (b) | 10.7 ± 1.7 (b) | 12.7 ± 3.6 (b) | 14.71, <0.0001 |
| | 8 d | 54.0 ± 6.5 (a) | 16.7 ± 4.6 (b) | 26.0 ± 3.1 (b) | 19.3 ± 2.8 (b) | 14.59, <0.0001 |
| | 10 d | 73.3 ± 10.0 (a) | 20.3 ± 4.7 (b) | 38.7 ± 4.8 (b) | 26.0 ± 2.7 (b) | 14.85, <0.0001 |
| | 12 d | 88.7 ± 5.5 (a) | 35.3 ± 8.1 (b) | 48.7 ± 6.7 (b) | 32.0 ± 3.9 (b) | 17.47, <0.0001 |
| Colony 2 | 2 d | 22.0 ± 4.9 (a) | 12.7 ± 4.1 (ab) | 0.7 ± 0.7 (b) | 4.7 ± 1.6 (b) | 8.13, 0.0010 |
| | 4 d | 38.0 ± 6.7 (a) | 16.8 ± 4.3 (b) | 12.0 ± 3.4 (b) | 8.7 ± 1.9 (b) | 9.15, 0.0006 |
| | 6 d | 57.3 ± 6.6 (a) | 18.4 ± 4.1 (b) | 24.7 ± 3.0 (b) | 20.0 ± 1.5 (b) | 18.99, <0.0001 |
| | 8 d | 78.0 ± 9.0 (a) | 25.6 ± 6.1 (b) | 33.3 ± 4.1 (b) | 24.7 ± 2.2 (b) | 18.81, <0.0001 |
| | 10 d | 93.3 ± 4.5 (a) | 37.2 ± 6.8 (b) | 41.3 ± 2.7 (b) | 28.0 ± 2.5 (b) | 50.71, <0.0001 |
| | 12 d | 100.0 ± 0.0 (a) | 53.6 ± 9.4 (b) | 51.3 ± 3.5 (b) | 30.7 ± 2.5 (c) | 42.52, <0.0001 |

*Different letters represent significant difference among group sizes within each time period (P < 0.05).

### Example 20

### Termites Exposed to S. Marcescens

For termite colony 1 (Table 4), from day 2 to 12 there were no significant differences among the 4 treatments: termites pre-fed on lufenuron-treated filter paper and exposed to S. marcescens (LU-SM), only exposed to S. marcescens (SM), only pre-fed on lufenuron-treated filter paper (LU), and control (P>0.05).

For termite colony 2 (Table 4), on day 2 and 4 mortality in the treatment LU-SM was significantly higher than that in the treatment SM or control (P<0.05, data not shown). None of them were significantly different from the treatment LU. From day 8 to 12, mortality of the treatment LU-SM was significantly higher than that of the control (P<0.05); neither was significantly different from the treatment LU or SM. The infected termites were red after they died.

TABLE 4
Daily mortality (mean ± SEM) of termites: (1) both pre-treated with lufenuron and
exposed to S. marcescens (LU-SM), (2) only pre-treated with lufenuron (LU), (3) only
exposed to S. marcescens (SM), and (4) neither pre-treated with lufenuron nor exposed
to S. marcescens (control).

| | | Mortality (%) | | | | |
|---|---|---|---|---|---|---|
| termite colony | day | LU-SM | LU | SM | control | F, P |
| Colony 1 | 2 d | 6.0 ± 2.5 (a*) | 4.0 ± 2.5 (a) | 0.7 ± 0.7 (a) | 0.7 ± 0.7 (a) | 2.06, 0.1372 |
| | 4 d | 13.3 ± 5.2 (a) | 5.3 ± 2.2 (a) | 5.3 ± 1.3 (a) | 2.7 ± 0.8 (a) | 2.45, 0.0934 |
| | 6 d | 17.3 ± 5.6 (a) | 8.7 ± 3.2 (a) | 15.3 ± 2.8 (a) | 12.7 ± 3.6 (a) | 0.89, 0.4617 |
| | 8 d | 21.3 ± 6.2 (a) | 16.7 ± 4.6 (a) | 28.0 ± 4.6 (a) | 19.3 ± 2.8 (a) | 1.06, 0.3866 |
| | 10 d | 26.0 ± 7.2 (a) | 20.3 ± 4.7 (a) | 37.3 ± 5.2 (a) | 26.0 ± 2.7 (a) | 1.87, 0.1666 |
| | 12 d | 32.7 ± 7.4 (a) | 35.3 ± 8.1 (a) | 45.0 ± 4.0 (a) | 32.0 ± 3.9 (a) | 0.95, 0.4331 |
| Colony 2 | 2 d | 17.3 ± 2.5 (a) | 12.7 ± 4.1 (ab) | 5.3 ± 0.8 (b) | 4.7 ± 1.6 (b) | 5.75, 0.0053 |
| | 4 d | 24.7 ± 3.2 (a) | 16.8 ± 4.3 (ab) | 12.0 ± 2.3 (b) | 8.7 ± 1.9 (b) | 5.86, 0.0052 |
| | 6 d | 33.3 ± 4.2 (a) | 18.4 ± 4.1 (a) | 24.0 ± 5.0 (a) | 20.0 ± 1.5 (a) | 2.93, 0.0598 |
| | 8 d | 44.0 ± 3.4 (a) | 25.6 ± 6.1 (ab) | 34.7 ± 7.4 (ab) | 24.7 ± 2.2 (b) | 3.15, 0.0489 |
| | 10 d | 54.0 ± 3.1 (a) | 37.2 ± 6.8 (ab) | 42.0 ± 8.2 (ab) | 28.0 ± 2.5 (b) | 3.90, 0.0250 |
| | 12 d | 70.7 ± 2.5 (a) | 53.6 ± 9.4 (ab) | 47.3 ± 10.0 (ab) | 30.7 ± 2.5 (b) | 6.13, 0.0043 |

*Different letters represent significant difference among group sizes within each time period (P < 0.05).

### Example 21

### Termites Exposed to B. Thuringiensis Subsp. Israelensis

For termite colony 1 (Table 5), from day 2 to 12 no significant difference in mortality was detected among the treatments: termites pre-fed on lufenuron-treated filter paper and exposed to B. thuringiensis (LU-BTI), only exposed to B. thuringiensis (BTI), only pre-fed on lufenuron-treated filter paper (LU), and control (P>0.05).

For termite colony 2 (Table 5), on day 2 and 4 mortality of the treatment LU was significantly higher than that of the treatment BTI (P<0.05), but neither of them was significantly different from the treatment LU-BTI or from control. From day 6 to 10, there was no significant difference in mortality among the four treatments (P>0.05). On day 12, mortality of the treatment LU-BTI was significantly higher than control (F_{3, 19}=3.19, P=0.0291). Neither of them was significantly different from the treatment LU or BTI.

TABLE 5
Daily mortality (mean ± SEM) of termites: (1) both pre-treated with lufenuron and
exposed to B. thuringiensis subspecies israelensis (LU-BTI), (2) only pre-treated with
lufenuron (LU), (3) only exposed to B. thuringiensis subspecies israelensis (BTI), and (4)
neither pre-treated with lufenuron nor exposed to B. thuringiensis subspecies israelensis
(control).

| | | Mortality (%) | | | | |
|---|---|---|---|---|---|---|
| termite colony | day | LU-BTI | LU | BTI | control | F, P |
| Colony 1 | 2 d | 3.3 ± 1.6 (a*) | 4.0 ± 2.5 (a) | 1.3 ± 0.8 (a) | 0.7 ± 0.7 (a) | 0.99, 0.4158 |
| | 4 d | 4.7 ± 2.2 (a) | 5.3 ± 2.2 (a) | 4.7 ± 1.6 (a) | 2.7 ± 0.8 (a) | 0.46, 0.7469 |
| | 6 d | 10.0 ± 2.7 (a) | 8.7 ± 3.2 (a) | 12.7 ± 1.8 (a) | 12.7 ± 3.6 (a) | 0.42, 0.7429 |
| | 8 d | 18.3 ± 5.4 (a) | 16.7 ± 4.6 (a) | 27.3 ± 3.5 (a) | 19.3 ± 2.8 (a) | 1.28, 0.3085 |
| | 10 d | 25.3 ± 6.8 (a) | 20.3 ± 4.7 (a) | 39.3 ± 4.1 (a) | 26.0 ± 2.7 (a) | 2.90, 0.0604 |
| | 12 d | 32.7 ± 6.7 (a) | 35.3 ± 8.1 (a) | 44.7 ± 3.2 (a) | 32.0 ± 3.9 (a) | 1.01, 0.4101 |
| Colony 2 | 2 d | 5.3 ± 0.8 (ab) | 12.7 ± 4.1 (b) | 0.7 ± 0.7 (a) | 4.7 ± 1.6 (ab) | 3.86, 0.0249 |
| | 4 d | 8.7 ± 1.9 (ab) | 16.8 ± 4.3 (b) | 12.0 ± 3.4 (a) | 8.7 ± 1.9 (ab) | 3.27, 0.0438 |
| | 6 d | 20.7 ± 3.2 (a) | 18.4 ± 4.1 (a) | 24.7 ± 3.0 (a) | 20.0 ± 1.5 (a) | 0.15, 0.9301 |
| | 8 d | 39.3 ± 7.8 (a) | 25.6 ± 6.1 (a) | 33.3 ± 4.1 (a) | 24.7 ± 2.2 (a) | 1.48, 0.2529 |
| | 10 d | 56.0 ± 12.5 (a) | 37.2 ± 6.8 (a) | 41.3 ± 2.7 (a) | 28.0 ± 2.5 (a) | 2.59, 0.0830 |
| | 12 d | 68.7 ± 14.4 (a) | 53.6 ± 9.4 (ab) | 51.3 ± 3.5 (ab) | 30.7 ± 2.5 (b) | 3.73, 0.0291 |

*Different letters represent significant difference among group sizes within each time period (P < 0.05).

### Example 22

### Conclusion: Lufenuron and P. Aeruginosa Synergistically Combined To Kill Termites

For both tested termite colonies, lufenuron significantly increased the virulence of P. aeruginosa. However, the interaction of lufenuron with S. marcescens or Bti was not as strong as the interaction of lufenuron with P. aeruginosa; higher mortality was only observed in one of the colonies. A bacterial concentration of P. aeruginosa from about 10×10⁶ to about 1×10⁹ c.f.u. per gram of bait is effective when used with lufenuron in a bait matrix.

### Example 23

### Conclusion: Termite Social Behavior was Disrupted

It is well established that bacteria, protozoans, and termites have a complex co-evolutionary history. However, the potential antagonism of bacterial pathogens towards termites has not previously been fully appreciated. Our findings suggest that this symbiosis not only contributes to the “passive” disease resistance in termites, but also to “active” suppression of microbial pathogens. Large colony size and social interactions also help C. formosanus suppress microbial pathogens. Our experiments showed that termites that had been pre-fed lufenuron did not show normal carcass-burying behavior of dead cohorts that had been killed by the three bacterial pathogens we tested. Termites who had been treated with bacteria alone, and the control groups (i.e., the termites not pre-fed lufenuron) both covered all dead termites with paper pellets. By contrast, termites treated with lufenuron did not cover dead termites with paper pellets. This difference in behavioral patterns highlights the disruptive impact of the synergistic interaction between lufenuron and a bacterial pathogen.

### Clay Experiment Results

### Example 24

### Clay as an Attractant

In general, whether food was provided or not, significantly more termites aggregated in chambers containing clay blocks as compared to center or sand side chambers, with the exception of termite colony 2 under fed conditions at day 21 (Table 6).

TABLE 6
Percentage of termites aggregated in each of the three chambers under
starved or fed conditions.

| Termite | Nutrition | | Percentage of termites (%) | | | ANOVA results |
|---|---|---|---|---|---|---|
| colony | condition | Day | Clay | Center | Sand | (F; df; P) |
| C1 | Starved | 7 | 70.7 ± 9.4a^{a} | 8.3 ± 1.3^{b} | 21.0 ± 8.7^{b} | 19.70; 2, 15; <0.0001 |
| | | 14 | 83.7 ± 12.5^{a} | 5.0 ± 4.2^{b} | 11.3 ± 8.4^{b} | 23.57; 2, 15; <0.0001 |
| | | 21 | 83.2 ± 16.1^{a} | 1.3 ± 1.3^{b} | 15.6 ± 14.9^{b} | 11.92; 2, 14; 0.0014 |
| | Fed | 7 | 65.0 ± 4.6^{a} | 7.3 ± 0.7^{c} | 27.7 ± 4.3^{b} | 62.97; 2, 15; <0.0001 |
| | | 14 | 75.7 ± 10.7^{a} | 6.3 ± 2.7^{b} | 18.0 ± 8.2^{b} | 21.84; 2, 15; <0.0001 |
| | | 21 | 79.5 ± 16.0^{a} | 0.8 ± 0.8^{b} | 19.7 ± 16.1^{b} | 9.83; 2, 15; 0.0019 |
| C2 | Starved | 7 | 91.3 ± 5.5^{a} | 1.3 ± 0.8^{b} | 7.3 ± 4.6^{b} | 145.33; 2, 15; <0.0001 |
| | | 14 | 94.0 ± 3.4^{a} | 3.7 ± 3.3^{b} | 2.3 ± 2.0^{b} | 317.47; 2, 15; <0.0001 |
| | | 21 | 100.0^{a} | 0.0^{b} | 0.0^{b} | NA; 2, 15; <0.0001 |
| | Fed | 7 | 74.3 ± 4.7^{a} | 9.3 ± 2.3^{b} | 16.3 ± 3.1^{b} | 102.66; 2, 15; <0.0001 |
| | | 14 | 81.0 ± 10.8^{a} | 4.0 ± 1.7^{b} | 15.0 ± 9.2^{b} | 25.39; 2, 15; <0.0001 |
| | | 21 | 53.1 ± 18.4^{a} | 2.9 ± 2.9^{a} | 44.1 ± 18.4^{a} | 3.37; 2, 15; 0.0617 |

^{a,b} Numbers followed by different letters are significantly different at α = 0.05 (Tukey's HSD). Comparisons are made within the same row.

### Example 25

### Termite Tunnels in Clay

The clay clearly promoted aggregation of termites. The percentages of termites in the center and sand side chambers were similar. There was no significant difference in the length of tunnels at each observation period (fed and starved; data not shown), or consumption of filter paper at the end of the experiment (fed; data not shown). However, overall there was much more total tunneling on the clay side under both fed and starved conditions (Table 7).

TABLE 7
Additive length of tunnels (mm) made in
clay side, center, or sand side chambers.

| Nutrition | | Additive length of tunnels (mm) | | |
|---|---|---|---|---|
| condition | Day | Clay | Center | Sand |
| Starved | 7 | 519 | 68 | 415 |
| | 14 | 533 | 68 | 481 |
| | 21 | 578 | 239 | 511 |
| Fed | 7 | 299 | 112 | 202 |
| | 14 | 546 | 162 | 320 |
| | 21 | 568 | 186 | 320 |

### Example 26

### Manipulation of Clay by Termites

Manipulation of clay was observed in both fed and starved tests. Termites made clay pellets and spread them on the substrate, or attached them to the smooth surface of the chamber walls (data not shown).

### Example 27

### Conclusions

Our observations showed that significantly and substantially more termites aggregated in the chambers containing a small amount of clay, regardless of colony group, observation period, or nutritional status (fed or starved). Although tunneling activity and food consumption were similar whether clay was present or not, these data showed that clay acts as an attractant to termites—a finding that we believe has not previously been reported.

### Bti Experiment Results

### Example 28

### Experiments with Mosquito Dunks

We have successfully controlled termites using Mosquito Dunks®, a commercial product that contains Bti spores, Bti solids, and Bti-produced insecticidal toxins, and that has a relatively long active time. Mosquito Dunks® are formulated with unspecified inert ingredients that we believe include clay. In our tests, 50 termites from two colonies were released in replicates of three treatments: (1) Bti dunk treatment—a single dunk was placed on the termite food (filter paper) in each replicate; (2) autoclaved dunk treatment—an autoclaved (121° C., 4 hours) dunk was placed on filter paper in each replicate; and (3) control treatment—only filter paper was provided.

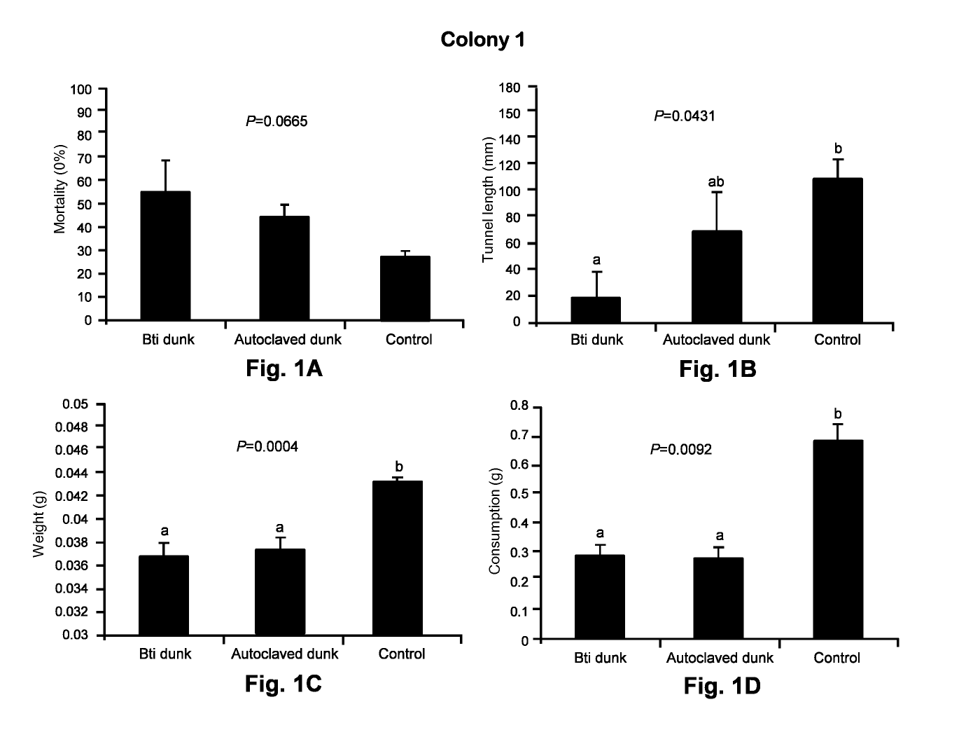

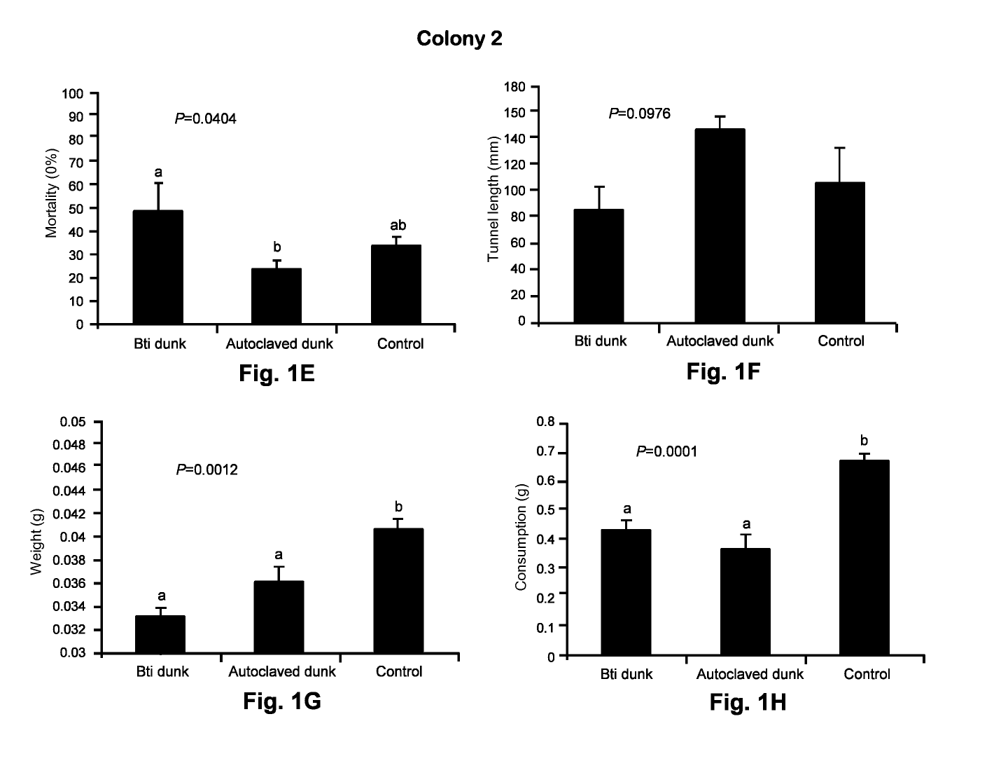

After 31 days, the mortality, tunnel length, consumption and average weight of termites were recorded. The results showed that termites made tunnels inside the Mosquito Dunk® material. Termites fed with filter paper with Mosquito Dunks® had the highest mortality and lowest tunneling activity. Both the non-treated and autoclaved Mosquito Dunks® significantly reduced the average weight and consumption of termites as compared with the controls. In one colony (colony 2), the mortality of termites feeding on untreated Mosquito Dunks® was significantly higher than that for termites feeding on autoclaved Mosquito Dunks®. The autoclaving presumably reduced Bti activity. FIG. 1A through H shows the mean mortality (±SE), tunnel length (±SE), weight of 10 termites (±SE), and consumption (±SE) by termites for the untreated Bti Mosquito Dunk®, the Autoclaved Mosquito Dunk®, and the control treatments. Different letters denote a significant difference (P<0.05).

### Example 29

### Clay in Mosquito Dunks

We found that clay enhances the effectiveness of Bti as a termiticide for subterranean termites. In the Mosquito Dunks®, clay appears to form part of the matrix used to disperse Bti. The alkaline and dry environment of the dunk is used to sustain long shelf life. Since Bti adheres to clay, clay makes a good matrix for a termite bait (along with cellulose).

### Example 30

### Embodiments of the Invention

We have discovered that Bti is effective in increasing mortality in subterranean termites. One form of this bait is the commercially available Mosquito Dunks®, which we found lead to an increase in mortality and a reduction in tunneling activity of Formosan subterranean termites. We expect that other subterranean species of the same family (Rhinotermitidae) such as Coptotermes, Heterotermes, and Reticulitermes will be similarly affected by Bti, and Bti-clay combinations, including for example Heterotermes aureus, Reticulitermes flavipes, R. virginicus, R. tibialis, R. hesperus, C. formosanus, C. acinaciniformis, and C. gestroi.

One embodiment for a termite bait in accordance with the present invention is to place in an area of suspected termite activity one or more commercially available Mosquito Dunks®, containing perhaps 2.5 billion to 3.0 billion colony forming units Bti per gram. This placement may be in the soil or inside a home where termite-feeding activity is found. Outside a home, the dunk can be placed directly in the location of termite activity (no plastic housing required). This can be repeated every month for as long as necessary. Inside a home or structure, the dunk may be placed in a container against the termite activity, and the material may be moistened to increase attraction.

Another embodiment for a termite control is to place effective amounts of Bti, clay, and cellulose into a bait station. The concentration of the Bti is preferably between about 2.5 and about 3.0 billion colony-forming units of Bti per gram. The amount of clay should be sufficient to maintain moisture and alkalinity of the Bti. Cellulose is used to bait the termites to come into the station, and can be any known cellulosic material, for example, wood, cardboard, paper, sawdust, etc.

Baits Containing a Chitin-Synthesis Inhibitor and Bacteria

We have shown for the first time that lufenuron can significantly decrease disease resistance of C. formosanus to bacterial pathogens, including not only toxin-producing bacteria such as B. thuringiensis, but also opportunistic pathogens such as P. aeruginosa. Our observations showed that P. aeruginosa alone is not particularly effective against C. formosanus. By contrast, P. aeruginosa in combination with lufenuron leads to high mortality. The P. aeruginosa strain we studied was previously isolated from C. formosanus. Since this bacterium is naturally associated with termites, developing a baiting system with P. aeruginosa and lufenuron should be environmental friendly and consumer-acceptable.

A bait can be made using a chitin synthesis inhibitor (CSI), including for example lufenuron, hexaflumuron, noviflumuron, diflubenzuron, novaluron; and pathogenic bacteria, including opportunistic pathogens, for example B. thuringiensis or P. aeruginosa. For example, a suitable range of lufenuron concentration by weight would be from about 0.025% to about 0.5%, preferably from about 0.05% to about 0.2%, most preferably about 0.1%. Bacterial concentrations are preferably from about 10⁶ to about 10¹⁰ c.f.u. per gram of bait, more preferably about 10⁹ c.f.u. per gram. In any event, the concentrations of the ingredients should be such as to cause substantial mortality in a termite colony that consumes the bait. An effective bait could be a combination of lufenuron and P. aeruginosa applied to paper, cardboard, wood, cellulose slurry, or other bait matrices, including clay. In one embodiment the bait has an outer layer containing a CSI compound, surrounding an interior matrix containing bacteria that are released into the bait upon wetting. Alternatively, the CSI could be contained in the center, surrounded by an agar base that supports bacterial growth. A good matrix for long-term maintenance of the bacteria would be an alginate-clay matrix (e.g., Fravel et al., 1985), that could be used with the same bait material or a different bait material containing lufenuron. As a further alternative, the initial trap/bait could be just a cellulosic material until termites are detected, and then the CSI and bacteria can be added after termites are noted.

Although our initial studies combining B. thuringiensis or S. marcescens with lufenuron did not show significantly higher termite mortality than lufenuron alone or bacteria alone, both bacterial species have numerous subspecies or strains, with differing virulence to insects. Other strains of B. thuringiensis or S. marcescens are expected to work well in combination with lufenuron. For example, Osbrink et al. (2001) isolated eight S. marcescens strains from dead termites and found that one strain, T8, showed extreme virulence to C. formosanus.

Lufenuron (or other CSI compound) may also be combined with other termite pathogens or opportunistic pathogens, including Lysinibacillus sphaericus (also known as Bacillus sphaericus), Serratia marcescens, Cedecea davisae, and P. fluorescens (the last of which is closely related to P. aeruginosa.) Genetically modified bacteria useful against termites may also be employed; see, e.g., U.S. Pat. No. 6,926,889.

Alternatively, a fungal pathogen or fungal opportunistic pathogen may be employed in this invention, e.g., Metarhizium anisopliae, Beauveria bassiana, or Aspergillus flavus.

Termites often tend to follow guidelines. Typical guidelines include such things as edges, spaces in soil where separation has occurred, moisture gradients, objects in the soil that provide an edge effect for termites to follow, and the like. Because clay is attractive to termites, clay may optionally be used as a guideline as well, to lead termites to baits—either baits in accordance with the present invention, or other types of termite baits. See generally L. Swoboda et al., “Laboratory assays evaluate the influence of physical guidelines on subterranean termite (Isoptera: Rhinotermitidae) tunneling, bait discovery, and consumption,” J. Econ. Entomol., vol. 97, pp. 1404-1412 (2004).

The complete disclosures of all references cited throughout the specification are hereby incorporated by reference in their entirety, as are the complete disclosures of priority applications Ser. Nos. 61/675,124 and 61/723,895. Also incorporated by reference are the complete disclosures of C. Wang et al., “Lufenuron suppresses the resistance of Formosan subterranean termites (Isoptera: Rhinotermitidae) to entomopathogenic bacteria,” J. Econ. Entomology, vol. 106 (in press, 2013); C. Wang et al., “Evidence of group size dependent suppression of entomopathogenic bacteria, Bacillus thuringiensis subspecies israelensis and thuringiensis, by Formosan subterranean termites (Isoptera: Rhinotermitidae),” poster presented at ESA Annual Meeting (Knoxville, Tenn., Nov. 11-14, 2012); and C. Wang et al., “Lufenuron suppresses the resistance of Formosan subterranean termites (Isoptera: Rhinotermitidae) to entomopathogenic bacteria,” poster presented at ESA Southeastern Branch Meeting (Baton Rouge, La. Mar. 3-6, 2013). In the event of an otherwise irresolvable conflict, however, the disclosure of the present specification shall control.

What is claimed:

1. An article of manufacture comprising a mixture of a chitin synthesis inhibitor and microorganisms, wherein:
(a) if said article is placed in the vicinity of a subterranean termite colony, then after a time said article will induce mortality in the termite colony;
(b) the article is such that, if said article is placed in the vicinity of a subterranean termite colony, then termites from the colony will ingest at least a portion of said article, whereby the termites will consume said chitin synthesis inhibitor and said microorganisms; and the chitin synthesis inhibitor and microorganisms will be transferred to other termites in the termite colony by trophallaxis or other interactions between termites;
(c) the concentration of said chitin synthesis inhibitor in said article is such that, if said article is placed in the vicinity of a subterranean termite colony, then termites from the colony will ingest a sufficient amount of said chitin synthesis inhibitor to weaken the immunity of the termites to infection by the microorganisms;
(d) said microorganisms are pathogens of termites, or said microorganisms are opportunistic pathogens of termites having weakened immunity; and the concentration of said microorganisms in said article is such that, if said article is placed in the vicinity of a subterranean termite colony, then termites from the colony will ingest sufficient microorganisms to induce mortality in the termite colony.

2. The article of claim 1, wherein said article additionally comprises cellulose.

3. The article of claim 1, wherein said article additionally comprises clay, wherein the concentration of clay in said article is such that, if said article is placed in the vicinity of a subterranean termite colony, then termites from the colony will ingest, on average, substantially more of said chitin synthesis inhibitor and said microorganisms than would be ingested from an otherwise substantially identical article lacking any clay; and the resulting mortality in the colony will be, on average, substantially higher than the mortality that would result from an otherwise substantially identical article lacking any clay.

4. The article of claim 3, wherein said article additionally comprises cellulose admixed with said chitin synthesis inhibitor; wherein said microorganisms are placed on the surface of said clay or said microorganisms are admixed with said clay; and wherein said article comprises an inner portion and an outer portion, wherein said inner portion comprises said cellulose/chitin synthesis inhibitor admixture, wherein said outer portion comprises said clay and said microorganisms, and wherein said outer portion fully or partially encloses said inner portion.

5. The article of claim 1, wherein said microorganisms comprise bacteria that are pathogens of termites, or bacteria that are opportunistic pathogens of termites having weakened immunity.

6. The article of claim 5, wherein said bacteria comprise Bacillus thuringiensis.

7. The article of claim 5, wherein said bacteria comprise Pseudomonas aeruginosa.

8. The article of claim 5, wherein said bacteria comprise one or more bacteria selected from the group consisting of Pseudomonas spp. and Serratia spp.

9. The article of claim 1, wherein said microorganisms comprise fungi that are pathogens of termites, or fungi that are opportunistic pathogens of termites having weakened immunity.

10. The article of claim 9, wherein said fungi comprise one or more fungi selected from the group consisting of Metarhizium anisopliae, Beauveria bassiana, and Aspergillus flavus.

11. The article of claim 1, wherein said chitin synthesis inhibitor is selected from the group consisting of lufenuron, hexaflumuron, noviflumuron, diflubenzuron, and novaluron.

12. The article of claim 1, wherein said chitin synthesis inhibitor comprises lufenuron.

13. The composition of claim 1, wherein said article additionally comprises cellulose, wherein said chitin synthesis inhibitor comprises lufenuron, and wherein said microorganisms comprise Bacillus thuringiensis subs. israelensis.

14. The article of claim 1, wherein said article additionally comprises cellulose, wherein said chitin synthesis inhibitor comprises lufenuron, and wherein said microorganisms comprise Pseudomonas aeruginosa.

15. A method for inducing mortality in a subterranean termite colony, said method comprising placing an article in the vicinity of the termite colony, and allowing sufficient time for the consumed article to induce mortality in the termite colony; wherein the article comprises a mixture of clay and a termite toxicant; wherein the concentration of clay in the article is such that, if said article is placed in the vicinity of a subterranean termite colony, then termites from the colony will ingest at least some of said article, and the toxicant will be transferred to other termites in the termite colony by trophallaxis or other interactions between termites; and wherein the termites will ingest, on average, substantially more of said toxicant than would be ingested from an otherwise substantially identical article lacking any clay; and wherein the resulting mortality in the colony will be, on average, substantially higher than the mortality that would result from an otherwise substantially identical article lacking any clay.

16. The method of claim 15, wherein the article additionally comprises cellulose.

17. The method of claim 15, wherein the termite toxicant comprises a chitin synthesis inhibitor and microorganisms, wherein:
(a) the concentration of the chitin synthesis inhibitor in the article is such that, when the article is placed in the vicinity of a subterranean termite colony, then termites from the colony will ingest a sufficient amount of the chitin synthesis inhibitor to weaken the immunity of the termites to infection by the microorganisms;
(b) the microorganisms are pathogens of termites, or the microorganisms are opportunistic pathogens of termites having weakened immunity; and the concentration of the microorganisms in the article is such that, when the article is placed in the vicinity of a subterranean termite colony, then termites from the colony will ingest sufficient microorganisms to induce mortality in the termite colony.
